(19) United States
(12) Patent Application Publication
(10) Pub. No.: US 2009/0133766 A1
(43) Pub. Date: May 28, 2009

(54) DUAL INLET AND DUAL OUTLET SPA VALVE

(76) Inventor: JOSEPH G. ELNAR, Riverside, CA (US)

Correspondence Address: AVERILL & VARN, 8244 PAINTER AVE., WHITTIER, CA, 90602, US

(21) Appl. No.: 11/945,159

(22) Filed: Nov. 26, 2007

(51) Int. Cl. F16K 11/00

(52) U.S. Cl. 137/625; 4/538

(57) ABSTRACT

A dual inlet and dual outlet valve controls a flow from dual inlet pipes through dual outlets to dual outlet pipes to increase flow where space is not available for a single larger diameter pipe. The valve includes a rotatable cylindrical plug with vertically spaced apart plug mouths. The plug may be rotated to align the plug mouths with one of both dual outlets to allow a flow to the dual outlet pipes, or the plug may be rotated to block the flow to both outlets. The dual inlet and dual outlet valve is particularly useful in a spa where narrow spa walls limit pipe sizes. The valve allows parallel pipes into the valve and from the valve to jets, thus increasing the water flow to the jets and the resulting turbulence.

### BACKGROUND OF THE INVENTION

The present invention relates to valves and in particular to spa valves.

Home spas have become very common and are a source of relaxation and relief from stress encountered in everyday life. Such home spas generally include a spa tub and a pump/filter/heater unit for circulating water and jets for returning the circulated water to the spa. Spa owners generally expect the jets to produce substantial turbulence in the water and are often disappointed by the actual result. One solution to increasing turbulence is to increase the pump size. While a larger pump has a capability to increase flow and therefore the turbulence created by the jets, the flow is also limited by the pipes carrying the flow to the jets.

Known spas have fairly thin spa walls. Given the insulation in the walls, there is only room for approximately two inch diameter pipes. This limitation on pipe size prevents taking full advantage of larger pumps.

### BRIEF SUMMARY OF THE INVENTION

The present invention addresses the above and other needs by providing a dual inlet and dual outlet valve which controls a flow from dual inlet pipes through dual outlets to dual outlet pipes to increase flow where space is not available for a single larger diameter pipe. The valve includes a rotatable cylindrical plug with vertically spaced apart plug mouths. The plug may be rotated to align the plug mouths with one of both dual outlets to allow a flow to the dual outlet pipes, or the plug may be rotated to block the flow to both outlets. The dual inlet and dual outlet valve is particularly useful in a spa where narrow spa walls limit pipe sizes. The valve allows parallel pipes into the valve and from the valve to jets, thus increasing the water flow to the jets and the resulting turbulence.

In accordance with one aspect of the invention, there is provided a spa having a spa tub wall for holding water, at least one drain on a surface of the spa tub for receiving a flow of water from the spa tub, a filter for filtering the flow of water, a heater for heating the flow of water, jets for returning the flow of water to the spa, a pump for circulating the flow of water from the spa drain through the filter and heater to the jets and a valve residing inside the spa wall for controlling the flow of water. The valve includes a cylindrical valve body and a rotatable cylindrical plug for controlling the flow of water passing through the valve. The cylindrical valve body has two approximately two inch diameter round inlets into the valve body and two approximately two inch diameter vertically apart outlets from the valve body, opposite the vertically spaced apart inlets. The cylindrical plug resides inside the body and is rotatable to control the flow of water through the valve. A valve handle resides above the valve body and is connected to the plug for turning the plug from the closed position to the open position. Parallel first and second inflow pipes reside side by side in the spa tub wall connecting the round inlets to the flow of water and parallel first and second outflow pipes reside side by side in the spa tub wall connecting the round outlets to the jets.

In accordance with another aspect of the invention, there is provided a valve plug having vertically spaced apart paths alignable with the inlets and outlets. The plug has an open position wherein the paths allow a flow through the valve from the inlets to the outlets, and a closed position wherein the plug blocks the flow through the valve from the inlets to the outlets.

In accordance with yet another aspect of the invention, there is provided a valve plug having a first position wherein the plug mouths are aligned with one of the outlets to allow the flow of water to pass through the valve into one of the outlets, a second position wherein the plug mouths are aligned with both of the outlets to allow the flow of water to pass through the valve into both of the outlets, and a third position wherein the plug mouths are not aligned with either outlet to prevent the flow of water passing through either of the outlets.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows the elements of a prior art spa.

FIG. 2 shows a spa with a dual inlet and outlet valve and dual pipes according to the present invention.

FIG. 3 is a view of the dual inlet and outlet valve and dual pipes according to the present invention with the spa wall cut away.

FIG. 4 is a more detailed view of the dual inlet and dual outlet valve.

FIG. 5A is a cross-sectional view of the dual inlet and dual outlet valve taken along line 5-5 of FIG. 4, with the valve fully closed.

FIG. 5B is a cross-sectional view of the dual inlet and dual outlet valve taken along line 5-5 of FIG. 4, with the valve fully open.

FIG. 6 is a view of a second embodiment of a dual inlet and outlet valve and dual pipes according to the present invention with the spa wall cut away.

FIG. 7 is a more detailed view of the second embodiment of the dual inlet and dual outlet valve.

FIG. 8A is a cross-sectional view of the dual inlet and dual outlet valve taken along line 8-8 of FIG. 7, with a first outlet open and a second outlet closed.

FIG. 8B is a cross-sectional view of the dual inlet and dual outlet valve taken along line 8-8 of FIG. 7, with both the first outlet and the second outlet open.

FIG. 8C is a cross-sectional view of the dual inlet and dual outlet valve taken along line 8-8 of FIG. 7, with both outlets closed.

FIG. 9 is a view of a third embodiment of a dual inlet and outlet valve and dual pipes according to the present invention with the spa wall cut away.

FIG. 10 is a more detailed view of the third embodiment of the dual inlet and dual outlet valve.

FIG. 11A is a cross-sectional view of the dual inlet and dual outlet valve taken along line 11-11 of FIG. 10, with a first outlet open and a second outlet closed.

FIG. 11B is a cross-sectional view of the dual inlet and dual outlet valve taken along line 11-11 of FIG. 10, with both the first outlet and the second outlet open.

FIG. 11C is a cross-sectional view of the dual inlet and dual outlet valve taken along line 11-11 of FIG. 10, with the first outlet closed and the second outlet open.

FIG. 12A is a cross-sectional view of the dual inlet and dual outlet valve taken along line 12-12 of FIG. 10, with a first outlet open and a second outlet closed.

FIG. 12B is a cross-sectional view of the dual inlet and dual outlet valve taken along line 12-12 of FIG. 10, with both the first outlet open and the second outlet open.

FIG. 12C is a cross-sectional view of the dual inlet and dual outlet valve taken along line 12-12 of FIG. 10, with the first outlet closed and a second outlet open.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

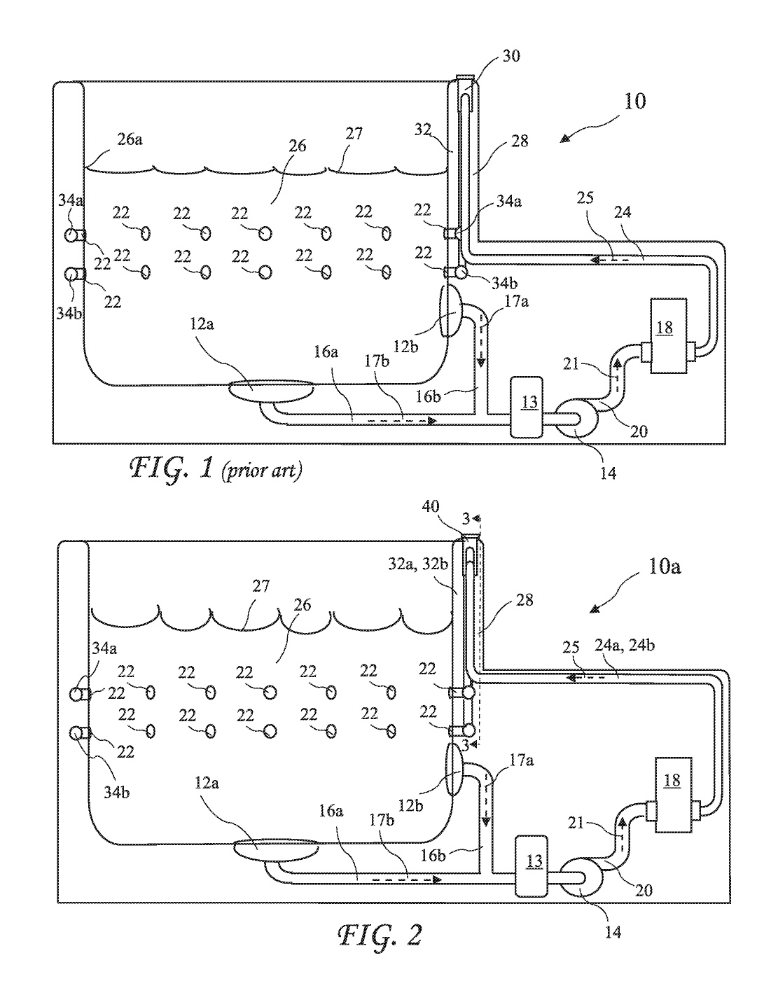

A prior art spa 10 is shown in FIG. 1. The spa 10 includes drains 12a and 12b. The drains 12a, 12b below a spa water line 26a are in fluid communication with a pump 14 through first pipes 16a and 16b carrying flows 17a and 17b of water 26 respectively, through a filter 13 and to the pump 14. A spa heater 18 is in fluid communication with the pump 14 through a second pipe 20 carrying second flow 21. The heater 18 is in fluid communication with jets 22 through inflow pipe 24, a valve 30, and an outflow pipe 32 carrying a heated flow 25 down to horizontal pipes 34a and 34b circling the spa and connected to the jets 22. The water is returned to the spa by the jets 22 creating turbulence 27 in the spa. Unfortunately, the pipes 24 and 32 are limited to about a two inch diameter by the spa wall 28 thickness and insulation in the spa wall 28 because the walls 28 are generally narrow walls. As a result of flows restrictions in the pipes 24 and 32, the flow to the jets 22 and the resulting turbulence, is often less than desired by spa users.

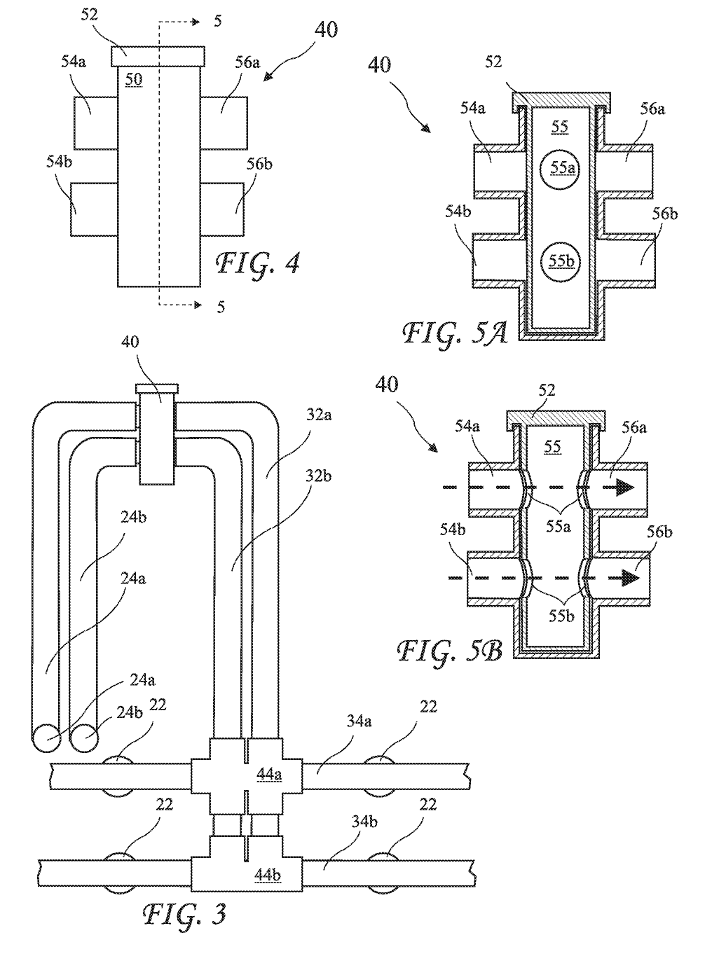

A spa 10a according to the present invention is shown in FIG. 2. The spa 10a is similar to the prior art spa 10, except the spa 10a includes a dual inlet and outlet valve 40, and the pipes 24 and 32 are replaced with parallel inflow pipes 24a and 24b, and parallel outflow pipes 32a and 23b respectively residing vertically side by side inside and spaced apart along the narrow spa wall (see FIG. 3). The pipes 24a, 24b, 32a, and 32b are preferably each between approximately 1.5 inches and three inches in diameter, and each are more preferably approximately two inches in diameter, thus fitting within the space available in the spa wall 28 and providing twice the flow capacity of the single pipes of the spa 10, thus significantly increasing the turbulence 27 in the spa 10a.

A view of the dual inlet and outlet valve 40 and dual pipes according to the present invention is shown in FIG. 3 with the spa wall cut away. A pair of inflow pipes 24a and 24b carry the flow of water into the valve 40 and a pair of outflow pipes 32a and 32b carry the flow of water out of the valve 40 to the horizontal pipes 34a and 34b. The inflow pipes 24a and 24b and the outflow pipes 32a and 32a reside side by side inside the spa wall 28, spaced apart along the wall to allow the largest pipe diameter. Specifically, inflow pipes 24a and 24b and the outflow pipes 32a and 32a are spaced apart along the spa wall 28 length so that inflow pipes 24a and 24b and the outflow pipes 32a and 32a do not interfere with each other. Such side by side spacing of parallel pipes allows a maximum pipe size and maximum flow within the pairs of pipes.

A more detailed view of the dual inlet and dual outlet valve 40 is shown in FIG. 4, a cross-sectional view of the dual inlet and dual outlet valve 40 taken along line 5-5 of FIG. 4, with the valve fully closed is shown in FIG. 5A, and a cross-sectional view of the dual inlet and dual outlet valve 40 taken along line 5-5 of FIG. 4, with the valve fully open is shown in FIG. 5B. The valve 40 includes dual vertically spaced apart inlets 54a and 54b, dual vertically spaced apart outlets 56a and 56b, a cylindrical valve body 50, and a handle 52 for opening and closing the valve 40. The inlets 54a and 54b and outlets 56a and 56b are preferably round and are preferably approximately two inches in diameter. The handle 52 may be used to rotate a plug 55 having two pairs of angularly aligned (i.e., one directly below the other) plug mouths 55a and 55b. The plug mouths 55a and 55b may be completely aligned with the inlets 54a and 54b and the outlets 56a and 56b to fully open the valve 40 as shown in FIG. 5B, or the plug mouths 55a and 55b may be turned 90 degrees from the inlets 54a and 54b and the outlets 56a and 56b to fully close the valve 40 as shown in FIG. 5A, or the plug mouths 55a and 55b may be turned to partially overlap the inlets 54a and 54b and the outlets 56a and 56b to partially open the valve 40.

As seen in FIG. 4 and the following figures, the inlets and outlets reside on opposite sides of the valve body, and are thus spaced apart by approximately 180 degrees to allow the pipes to reside side by side inside the narrow spa wall. The inlets and outlets may also all reside on the same side of the valve body, which is equivalent to being spaced apart by approximately 360 degrees. In the most general case, the inlets and outlets are therefor spaced apart by integer multiples of approximately 180 degrees.

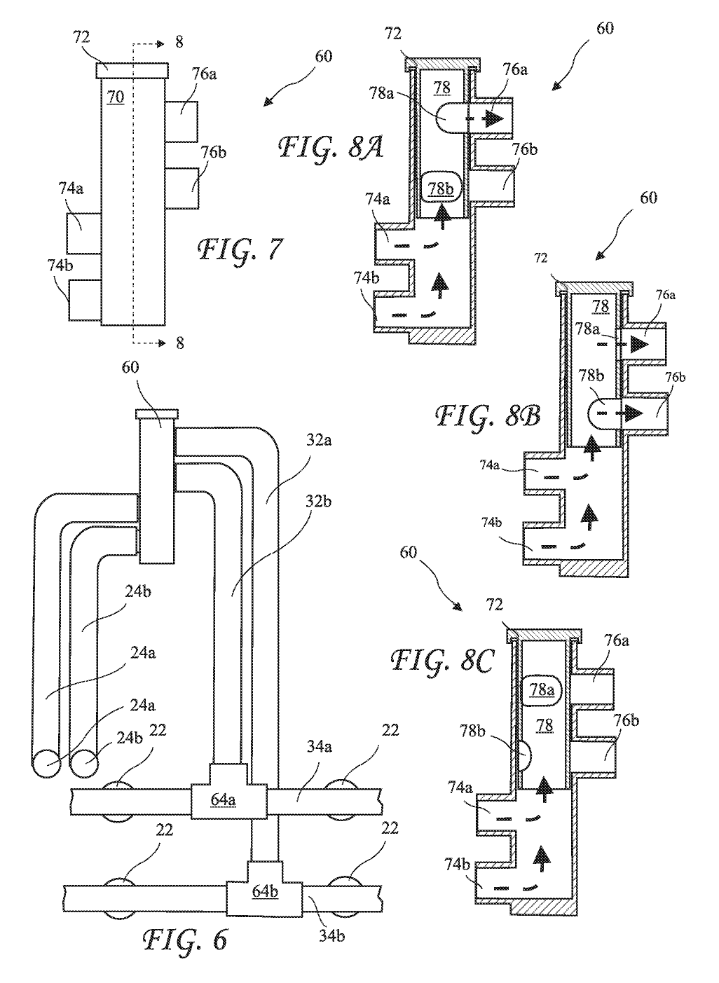

A second dual inlet and outlet valve 60 and dual pipes according to the present invention is shown in FIG. 6 with the spa wall cut away. The pair of inflow pipes 24a and 24b carry the flow of water into the valve 60 and the pair of outflow pipes 32a and 32b carry the flow of water out of the valve 60. The inflow pipes 24a and 24b and the outflow pipes 32a and 32a reside side by side inside the spa wall 28, spaced apart along the wall to allow the largest pipe diameter which fits inside the narrow spa walls. Lower in the spa wall, more room is available where the pipe 32a may cross the pipe 34a where necessary, or oval pipe sections may be used where the pipes cross. Specifically, inflow pipes 24a and 24b and the outflow pipes 32a and 32a are spaced apart along the spa wall 28 length so that inflow pipes 24a and 24b and the outflow pipes 32a and 32a do not interfere with each other. Such side by side spacing of parallel pipes allows a maximum pipe size and maximum flow within the pairs of pipes. In this embodiment, the outflow pipe 32a provides a flow to the upper horizontal pipe 34a only, and the outflow pipe 32b provides a flow to the lower horizontal pipe 34b only.

A view of the second dual inlet and dual outlet valve 60 only is shown in FIG. 7, a cross-sectional view of the dual inlet and dual outlet valve 60 taken along line 8-8 of FIG. 7, with a first outlet 76a fully open and a second outlet 76b fully closed, is shown in FIG. 8A, a cross-sectional view of the dual inlet and dual outlet valve 60 taken along line 8-8 of FIG. 7, with both the first outlet 76a and the second outlet 76b open, is shown in FIG. 5B, and a cross-sectional view of the dual inlet and dual outlet valve 60 taken along line 8-8 of FIG. 7, with both the first outlet 76a and the second outlet 76b closed, is shown in FIG. 8C. The valve 60 includes dual vertically spaced apart inlets 74a and 74b which are below a plug 78 and always open to allow a flow into the valve body 70. The flow of water into the valve 60 may be provided by other embodiments, for example into the bottom of the valve or into opposite sides of the valve, and any embodiment connecting two inflow pipes to the valve 60 is intended to come within the scope of the present invention.

The plug 78 includes angularly separated upper plug mouth 78a and lower plug mouth 76b. The plug mouths 78a and 78b are preferably oval and are angularly separated (i.e., staggered) so that one of the plug mouths 78a and 78b may be aligned with one of the outlets 76a and 76b, both of the plug mouths 78a and 78b may be aligned with both of the outlets 76a and 76b, and both of the plug mouths 78a and 78b may be rotated out of alignment with both the outlets 76a and 76b. The cylindrical plug 78 may also be rotated so that the plug mouths 78a and 78b are partially aligned with the outlets 76a and 76b.

In FIG. 8A, the plug mouth 78a is rotationally aligned with the first outlet 76a to allow a flow of water through the valve 60 and out of the first outlet 76a, and flow through the second outlet 76b is blocked. In FIG. 8B, the plug mouth 78a is rotationally aligned with the first outlet 76a and the plug mouth 78b is rotationally aligned with the second outlet 76b to allow a flow of water through the valve 60 and out of both the first outlet 76a and the second outlet 76b. In FIG. 8C, the plug mouth 78a is rotationally out of alignment with the first outlet 76a and the plug mouth 78b is rotationally out of alignment with the second outlet 76b to prevent a flow of water through the valve 60 and out of either the first outlet 76a or the second outlet 76b.

The plug 78 may be rotated to completely align or partially align either plug mouth with the corresponding outlet. Further, the plug mouths may be other shapes to provide a desired combination of flows to the upper and lower jets, or to any configuration of jets and any spa valve structure utilizing two or more parallel pipes to provide greater flow is intended to come within the scope of the present invention.

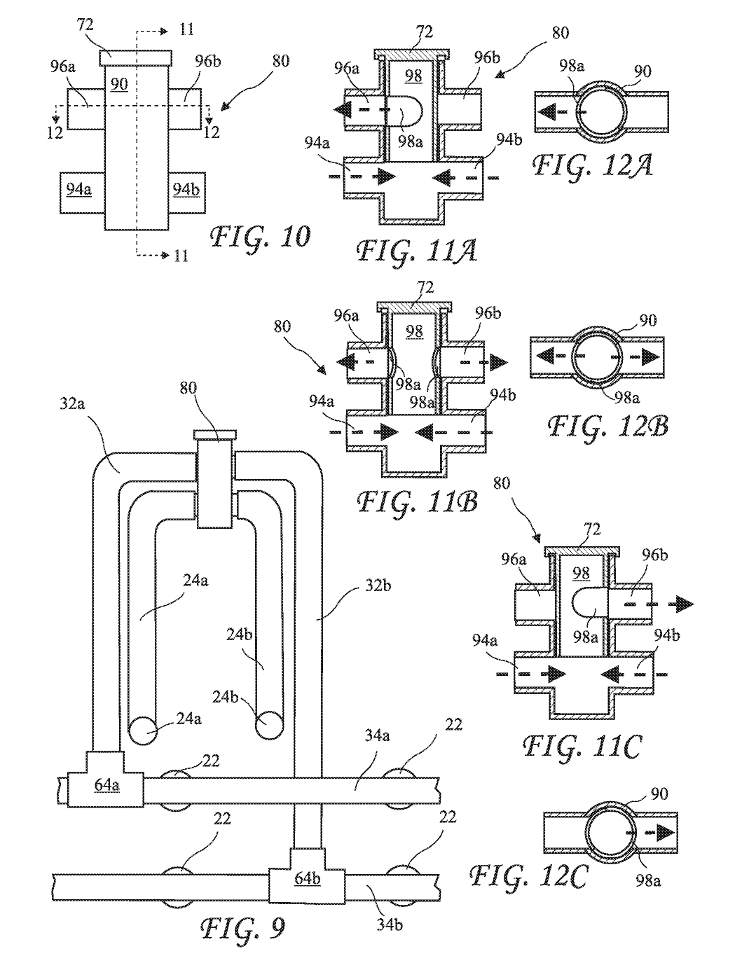

A view of a third embodiment of a dual inlet and outlet valve 80 and dual pipes according to the present invention, with the spa wall cut away, is shown in FIG. 9 and a more detailed view of the third embodiment of the dual inlet and dual outlet valve 80 alone is shown in FIG. 10. The inflow pipes 24a and 24b enter the valve 80 on opposite sides opposite one another. The outflow pipes 32a and 32b exit the valve 80 above the inflow pipes 24a and 24b on opposite sides opposite one another.

A cross-sectional view of the valve 80 taken along line 11-11 of FIG. 10, with a first outlet 96a open and a second outlet 96b closed is shown in FIGS. 11A and 12A, a cross-sectional view of the valve 80 taken along line 11-11 of FIG. 10, with both the first outlet 96a and the second outlet 96b open is shown in FIGS. 11B and 12B, and a cross-sectional view of the dual inlet and dual outlet valve taken along line 11-11 of FIG. 10, with the first outlet 96a closed and the second outlet 96b open is shown in FIGS. 11C and 12C. A second plug 98 resides inside a second valve body 90. An oval plug mouth 98a resides in the plug 98. The plug 98 may be rotated to align the mouth 98a with the first outlet 96a only (shown in FIGS. 11A and 12A), with both outlets 96a and 96b (shown in FIGS. 11B and 12B), and with the second mouth 96b only (shown in FIGS. 11C and 12C).

FIG. 12B is a cross-sectional view of the dual inlet and dual outlet valve taken along line 12-12 of FIG. 10, with both the first outlet open and the second outlet open.

FIG. 12C is a cross-sectional view of the dual inlet and dual outlet valve taken along line 12-12 of FIG. 10, with the first outlet closed and a second outlet open.

While the valve of the present invention is shown as having a handle for manual actuation, the valve may also be actuated by an electric motor, be air actuated, or be actuated by any other means, and a valve according to the present invention with any actuation means is intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. A multi inlet and multi outlet valve comprising:
a cylindrical valve body including:
at least two spaced apart inlets into the valve body; and
at least two spaced apart outlets from the valve body, the inlets and outlets residing on one of a same side of the valve body and opposite sides of the valve body;
a rotatable cylindrical plug residing inside the valve body with at least one plug mouth alignable with the outlets, and
an actuation means connected to the plug for rotating the plug mouth into alignment and out of alignment with the outlets.

2. The valve of claim 1, wherein the at least two spaced apart outlets are vertically spaced apart and angularly aligned on the valve body.

3. The valve of claim 2, wherein the plug mouths are round openings in the plug and are vertically spaced apart and angularly aligned.

4. The valve of claim 3, wherein:
the spaced apart inlets comprise two round vertically spaced apart inlets; and
the at least two outlets comprise two round vertically spaced apart outlets.

5. The valve of claim 4, wherein:
the two round vertically spaced apart inlets are between approximately 1.5 inches and approximately three inches in diameter; and
the two round vertically spaced apart outlets are between approximately 1.5 inches and approximately three inches in diameter.

6. The valve of claim 5, wherein:
the two round vertically spaced apart inlets are approximately two inches in diameter; and
the two round vertically spaced apart outlets are approximately two inches in diameter.

7. The valve of claim 1, wherein the plug has a partially open position wherein the plug mouths are partially aligned with at least one of the outlets to allow a partial flow through the valve.

8. The valve of claim 1, wherein the plug mouths are vertically spaced apart and angularly staggered.

9. The valve of claim 8, wherein the plug mouths are oval.

10. The valve of claim 9, wherein:
the at least two spaced apart outlets comprise first and second vertically spaced apart outlets;
the plug mouths comprise first and second oval vertically spaced apart and angularly staggered plug mouths; and
the plug is rotatable to positions to the plug mouths to:
angularly align the first plug mouth with the first outlet and angularly separate the second plug mouth from the second outlet;
angularly align the first plug mouth with the first outlet and angularly align the second plug mouth from the second outlet; and
angularly separate the first plug mouth from the first outlet and angularly align the second plug mouth from the second outlet.

11. The valve of claim 1, wherein the actuation means is a handle.

12. The valve of claim 9, wherein the actuation means is an electric motor.

13. A spa comprising:
a narrow spa tub wall for holding water in the spa;
at least one drain on a surface of the spa tub wall below a spa water line for receiving a flow of water from the spa;
a filter connected by pipes to the at least one drain for filtering the flow of water;
a heater connected by the pipes in series with the filter for heating the flow of water;
jets connected by the pipes in series with the heater for returning the flow of water to the spa;
a pump connected in series with the filter and heater and to the jets, by the pipes, for circulating the flow of water from the spa drain through the filter and heater to the jets;
a valve residing inside the narrow spa tub wall for controlling the flow of water from the pump to the jets, the valve comprising:
a cylindrical valve body residing inside the narrow spa tub wall and including:
two between approximately 1.5 inch and approximately three inch diameter round inlets into the valve body connected to the inflow pipes for receiving the flow of water into the valve; and
two between approximately 1.5 inch and approximately three inch diameter round spaced apart outlets from the valve body connected to the outflow pipes for releasing the flow of water from the valve;
a rotatable cylindrical plug residing inside the body with at least one plug mouth alignable with the outlets, and
an actuation means connected to the plug for angularly positioning the plug;
parallel first and second, between approximately 1.5 inch and approximately three inch diameter, round inflow pipes residing vertically side by side, inside and spaced apart along the narrow spa wall, the inflow pipes connecting the inlets to the flow of water; and
parallel first and second, between approximately 1.5 inch and approximately three inch diameter, outflow pipes residing vertically side by side, inside and spaced apart along the narrow spa wall, the outflow pipes connecting the outlets to the jets.

14. The valve of claim 13, wherein:
the at least one plug mouth comprises vertically spaced apart first and second plug mouths;
the two outlets comprise vertically spaced apart first and second outlets; and
the cylindrical plug includes:
a first position wherein the first plug mouth is aligned with the first outlet to allow the flow of water to pass through the valve into the first outlet and the second plug mouth is out of alignment with the second outlet;
a second position wherein the first plug mouth is aligned with the first outlet to allow the flow of water to pass through the valve into the first outlet and the second plug mouth is aligned with the second outlet to allow the flow of water to pass through the valve into the second outlet; and
a third position wherein the second plug mouth is aligned with the second outlet to allow the flow of water to pass through the valve into the second outlet and the first plug mouth is out of alignment with the first outlet.

15. The valve of claim 13, wherein:
the at least one plug mouth comprises vertically spaced apart first and second plug mouths;
the two outlets comprise vertically spaced apart first and second outlets; and
the cylindrical plug includes:
a first position wherein the first plug mouth is out of alignment with the first outlet and the second plug mouth is out of alignment with the second outlet to prevent the flow of water from passing through the valve;
a second position wherein the first plug mouth is aligned with the first outlet to allow the flow of water to pass through the valve into the first outlet and the second plug mouth is aligned with the second outlet to allow the flow of water to pass through the valve into the second outlet.

16. The valve of claim 13, wherein:
the at least one plug mouth comprises a single oval plug mouth;
the two outlets comprise angularly spaced apart first and second outlets; and
the cylindrical plug includes:
a first position wherein the first plug mouth is aligned with the first outlet to allow the flow of water to pass through the valve into the first outlet and the second plug mouth is out of alignment with the second outlet;
a second position wherein the first plug mouth is aligned with the first outlet to allow the flow of water to pass through the valve into the first outlet and the second plug mouth is aligned with the second outlet to allow the flow of water to pass through the valve into the second outlet; and
a third position wherein the second plug mouth is aligned with the second outlet to allow the flow of water to pass through the valve into the second outlet and the first plug mouth is out of alignment with the first outlet.

17. A dual inlet and dual outlet valve comprising:
a cylindrical valve body including:
two approximately two inch diameter round inlets into the valve body; and
two approximately two inch diameter vertically spaced apart round outlets from the body;
a rotatable cylindrical plug residing inside the body, the cylindrical plug including:
two vertically spaced apart angularly staggered plug mouths, the plug mouths including angularly overlapping portions angularly alignable with the outlets to allow:
a flow through both outlets simultaneously;
the flow through only one of the outlets; and
to prevent the flow through either outlet; and
a handle above the valve body and connected to the plug for turning the plug from the closed position to the open position.
